(19) United States
(12) Patent Application Publication
(10) Pub. No.: US 2017/0134566 A1
(43) Pub. Date: May 11, 2017

(54) Mobile Phone

(71) Applicant: Kuo-Ching CHIANG, Taipei City (TW)

(72) Inventor: Kuo-Ching CHIANG, Taipei City (TW)

(21) Appl. No.: 15/405,326

(22) Filed: Jan. 13, 2017

Related U.S. Application Data
(63) Continuation-in-part of application No. 14/108,363, filed on Dec. 17, 2013.

(51) Int. Cl. H04M 1/725; H04W 12/08; H04L 29/06; H04W 12/06; H04W 4/00; G06K 9/00

(52) U.S. Cl. CPC H04M 1/72577; H04M 1/72555; H04W 4/008; G06K 9/00255; G06K 9/00288; H04L 63/0861; H04W 12/06; H04W 12/08; H04M 2250/52; H04M 2201/41; G06K 2009/00322

(57) ABSTRACT

A mobile phone comprises a control unit and a memory coupled to the control unit. A sensor is formed in the mobile phone for capturing a user's face image. A mimicked age estimation module is coupled to the control unit to generate a mimicked age of the user by the captured face image. An age identification module is coupled to the control unit for age identification.

### CROSS REFERENCE TO RELATED APPLICATION

This application is a continuation-in-part application of Ser. No. 14/108,363, filed on Dec. 17, 2013, the disclosure of which is hereby incorporated by reference herein in its entirety.

### TECHNICAL FIELD

The present invention relates generally to a mobile phone, and more particularly to a mobile phone allowable for accessing mobile phone by mimicked age estimation module.

### BACKGROUND OF RELATED ARTS

Telecommunication and internet follow the tread to develop more convenient product and service to the market. The communication is, therefore, booming day by day. The network, mobile device are the essential facility and device for the human daily life. The network service provider and device maker are continuously to offer better service and solution to the user. The number of devices that individuals use for communications and messaging has also multiplied. Such devices include computers, wireless phones or tablet. The electronic mail is a method of exchanging digital messages. Modern email operates across the Internet or other networks. Email servers accept, forward, deliver, and store messages. The device may coupes remote or local terminal mail system. Service providers are drivers that connect client applications to a messaging system. For example, MAPI service providers include: message store providers, address book or directory providers, and message transport providers. The service providers work with MAPI to create and send messages. When the client sent the message, the message store provider will check recipient that has valid address. Address book providers handle access to directory information. For example, address book providers store a recipient's name, address, and address type. Transport providers handle message transmission and reception. When an incoming message is detected, the transport provider informs the spooler and the message is delivered to the appropriate message store. To handle outgoing messages, the message store moves the message to the outbound queue, and the spooler transfers it to the appropriate transport providers. The first thing before logging the mail system is to enter the password and account name. However, the current electronic mail system is based on text. It is not convenient to the user.

### SUMMARY

A method of accessing an e-mail system includes steps of preparing a template by capturing a first bio-characteristic of a user by a bio-characteristic capturing device of a computing device, followed by storing the first bio characteristic in the computing device or in a remote server The next step is to activate an e mail system from the computing device; triggering the bio-characteristic capturing device of the computing device to capture a second bio-characteristic of the user; comparing the captured second bio-characteristic of the user with the first bio characteristic in the computing device or in the remote server. The system will allow the user access the e mail system when the second bio-characteristic matches with the first bio characteristic. The first bio-characteristic is replaced by the second bio characteristic to refresh a template.

The first bio characteristic is replaced by the second bio characteristic to refresh a template. The template includes fingerprint, eye image or face image. The bio-characteristic capturing device includes image sensor or microphone.

The template includes voiceprint, the bio-characteristic capturing device includes microphone.

Address book providers handle access to directory information. Message store providers handle the storage and retrieval of messages and other information for the users of client application.

A mobile phone comprises a control unit and a memory coupled to the control unit. A sensor is formed in the mobile phone for capturing a user's face image. A mimicked age estimation module is coupled to the control unit to generate a mimicked age of the user by the captured face image. An age identification module is coupled to the control unit for age identification. The mimicked age may be transmitted to a specified website or a vending machine by a wireless transmitting module. After the mimicked age is confirmed, the mobile phone allows accessing into the specified website or the vending machine for buying or transaction.

The mobile phone further comprises a light source formed on the mobile phone to project light to the user's face. The mobile phone further comprises a camera formed on the mobile phone. A video message is sent to a remote web system by WiFi or mobile communication protocol from the mobile phone. A specified website can be accessed if the mimicked age of the user exceeds a set age. The sensor is an image capturing device. The mobile phone further includes a voiceprint template. The mobile phone further comprises a microphone. The user is allowed to input a face image or fingerprint for user identification.

The mobile phone allows logging a specified website based-on said mimicked age of said user. A specified website is forbidden to be accessed in the mobile phone if said mimicked age of said user does not exceed a set age.

in another aspect, the mobile phone further comprises a wireless transmitting module coupled to said control unit to transmit said mimicked age from said mobile phone to external device for age identification.

### BRIEF DESCRIPTION OF THE DRAWINGS

FIG. 1 shows a diagram of a computing system according to the present invention.

FIG. 2 shows a flow chart for accessing the e-mail system according to the present invention.

FIG. 3 shows a flow chart of applying the mimicked age estimation module according to the present invention.

### DETAILED DESCRIPTION

The present invention relates generally to an electronic mail system. The portable device includes but not limited to cellular phone, PDA (personal digital assistant), smart phone, notebook, tablet and the equivalent thereof. The wireless communication portable device may include dual-way transmission protocol, such as GSM, CDMA or WCDMA, 4G. Alternatively, the transmission protocol includes WiFi protocol.

The present invention relates to electronic mail system. It can be applied to any suitable e-mail module, for instance, Microsoft Outlook, web mail system such as Google mail, hot mail, yahoo mail and any other web mail system. In one embodiment, the electronic mail system is incorporate with computing platform and operation system. Under such scheme, the electronic mail module may be utilized by the user for transmitting, receiving electronic mail. The electronic mail system includes pluralities of sub-modules, for example, including a calendar manager, a task list manager, a contact manager, a message manager (e-mail), and a notes manager. Although the preferred embodiment will be generally described in the context of a program and an operating system running on a personal computer, table, smart phone those skilled in the art will recognize that the present invention also can be implemented in conjunction with other program modules for other types of computers, or operation system Android, iOS.

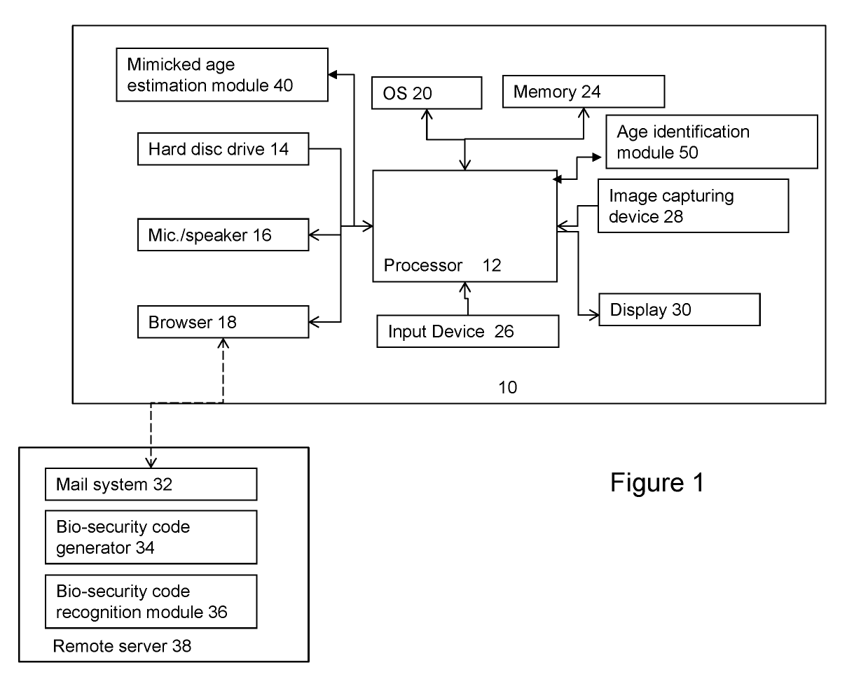

The electronic mail system is developed over ten years. However, these messages are simple text messages and are presented by text. The computing generally includes CPU, memory, display, I/O etc. The present invention may be applied to the heterogeneous distributed computing environment, for instance, remote server. As shown in FIG. 1, the computing device 10 such as computer, note book, tablet, smart phone, includes a processing unit 12 and memory 24, which is coupled to the processing unit 12. The computing device 10 may have BIOS which is a set of basic routines to transfer information between elements within the computing device 10. Those skilled in the art will also appreciate that the present invention may be used for computing devices without BIOS. A hard disk drive 14 is coupled to the processing unit 12. Some of the computing devices omit the hard drive. A user inputs instruction to the computing device 10 via input devices 26, such as a keyboard, mouse or touch screen. A display 30 is connected to the processing unit 14. OS 20 and applications 18 such as browser are stored on the computer readable medium. Microphone and speaker 16 are coupled to the processing unit 14, an image capturing device 28 is also coupled to the processing unit 14. A mimicked age estimation module 40 is coupled to the processing unit 12 to generate a mimicked age of the user by the captured face image. An age identification module 50 is coupled to the processing unit 12 for age identification. In one embodiment, the mimicked age estimation module 40 and the age identification module 50 are separate and independent module or program, respectively. In another embodiment, the mimicked age estimation module 40 and the age identification module 50 are combined into an integration module or program.

An Internet email message consists of three components, the message envelope, the message header, and the message body. The message header contains control information, including, minimally, an originator's email address and one or more recipient addresses. Usually descriptive information is also added. Messages are exchanged between hosts using the Simple Mail Transfer Protocol with software programs; and delivered to a mail store by programs called mail delivery agents. Users can retrieve their messages from servers using standard protocols such as POP or IMAP. Webmail interfaces allow users to access their mail with any standard web browser, from any computer, rather than relying on an email client. mail user agents (MUAs) used by users is provided for retrieving, reading, and managing email. Mail can be stored on the client, on the server side, or in both places. Server-side storage is often in a proprietary format but since access is through a standard protocol such as IMAP, moving email from one server to another can be done with any MUA supporting the protocol.

Web-based email (webmail) is the type of email. Many free email providers host their servers as web-based email (e.g. Hot Mail, Gmail, Outlook and Yahoo! Mail). This allows users to log into the email account by using a web browser to send and receive their email. POP3 is the acronym for Post Office Protocol 3. It is a leading email account type on the Internet. In a POP3 email account, email messages are downloaded to the client device and then they are deleted from the mail server. Other protocols IMAP, (Internet Message Access Protocol) provide more complete and complex remote access to typical mailbox operations. Another protocol is called Messaging Application Programming Interface (MAPI). The MAPI architecture is designed to make it easy for programmers to write messaging-enabled applications that are independent of the underlying messaging system. MAPI provides high-level function that can be used to implement sophisticated messaging features with a relatively small amount of code. The code deals with functions, for example, sending, receiving, and addressing messages. The underlying messaging system is completely transparent. Those skilled in the art will recognize that the present invention may be applied to any operation system and any mail protocol.

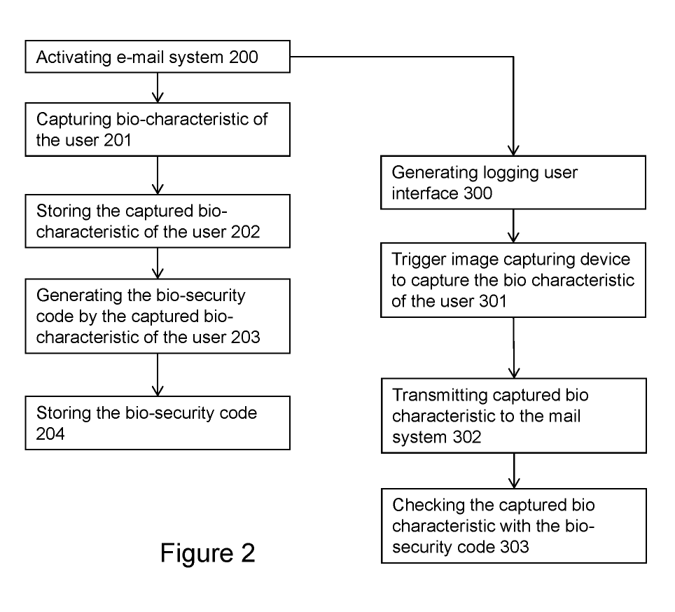

The present invention includes a step of activating the mail system 200 from the user terminal device 10. The mail system may be a local mail system or web-based mail system as shown in FIG. 2. The next step 201 is to prepare the security code for logging the mail system. In one embodiment, the invention introduces the bio-characteristic as the security code instead of text based password. The mail system activates the device to collect the bio-characteristic of the user. The bio characteristic includes face image, eye image, fingerprint or voice bio-characteristic. The face image, eye image, fingerprint bio-characteristic can be captured by image capturing device 28, the voice bio-characteristic is collected by microphone 16. After the template of the bio-characteristic is collected, the bio-characteristic is stored in local system or remote system in step 202, thereby generating the bio-security code by the bio-security code generator 34 in step 203. Then, the bio-security code is stored in local system or remote system in step 204.

If the user would like to send or receive e mail from the mail system 32 in the server 38, please refer to FIG. 2. After the user activates the mails system, the mail system 38 generates and transmits the user interface to the user terminal and displayed on the display 30 in step 300. The user bio-characteristic is captured by the image capturing device 28 or the microphone 16 in step 301. The user may not input the password and the user account due to the user oneself is actually the real “user account” and “password”. The captured bio-characteristic is transmitted to the mail system in the remote server or local system in step 302, followed by compare the stored bio-security code with the currently captured bio-characteristic by the bio-security code recognition module 36 in the remote server 38 in step 303. Preferably, dual source LED is used to project two spatially separated spots at the subject's pupil. The dual source LED is constructed by placing two LED side by side on the panel of the portable device. Back light from the subject's eye is detected by a sensor directly or via other optical mirror or lens. Another method is to detect the user image by the sensor. The sensor could be optical sensor such as CMOS sensor or CCD.

The method associated with the present invention includes the steps of activating the e-mail system. The electronic system includes text, or audio/video e-mail generator. The next step is to activate the e-mail generator to generate the e-mail, followed by triggering at least one of the microphone and digital camera or the like. The next step is to generate and prepare the text, audio/video e-mail by the text, or audio/video e-mail generator. Then, the user may transmit the text, or audio/video e-mail. A message store provider initiates the sending process, and delivers it to the appropriate transport provider. The transport provider gives the message to its messaging system, which sends it to the intended recipient(s). When the user opens the e-mail, it displays by the audio/video type instead of conventional text. The receiver may receive the audio message through the output of the speaker and the video signal is displayed on the display. Accordingly, the text message may be shown on the display as well. When the user would like to send the text, audio/video e-mail and input the instruction of creating a new mail, the user may initiate the generation of audio/video mail, then inputs the receipt address, or vice verse. The mentioned method above may be employed for the instant chat application for the logging.

Therefore, the e-mail system (instant chat application) is different from the prior message system. The method can be used in local mail system, web mail system, instant message system. Alternatively, the present invention may be integrated into the mobile phone terminal, table or PDA, thereby allowing the user may receive the message portably, and the user may omit to input the text word or message by one hand. The user may input the message by voice and/or video. If the system is based on the web base, the user may couple to the web mail service provider through the browser before receiving or sending mails. As mentioned, the wireless communication portable device may include dual-way transmission protocol, such as GSM, CDMA or 4G However, if the video data is required to be received and transmitted, simultaneously, the mobile communication protocol is well-known to be at least third generation mobile protocol, such as WCDMA or higher. From above, the mobile phone with at least third generation mobile protocol and the message generator comprises the e-mail generator provided to generate an e-mail or instant message. The message is processed by said generator and transmitted and received by said at least third generation mobile protocol. The present invention may allow the user portably receive the e-mail without inputting the text based password.

If the mobile phone includes internet work linking capability, namely, it integrated WLAN module into the device, it may couple to the network through the network linking module, for example WiFi, WiMax, 802.11 standard. The present invention changes the type of password. It provides better communication interface. Therefore, the user may send a true “password” by bio-characteristics. Thus, it offers better security interface for the user to login the message system. It also may allow the blind people to send a voice mail (message) even if he cannot see the keyboard or touch screen. When the user activates the message or e-mail system, the bio-characteristic capturing device will be triggered to automatically fetch the current bio-characteristic of the user, followed by accessing the message or mail system when the system identifies the user. Further, the user may refresh the template by using new captured bio-characteristic. The bio-characteristic may be changed due to the user gets older, for example, the face image maybe changed. Alternatively, the system maybe set to automatically alter the old bio-characteristic template by new captured bio-characteristic within one predetermined cycle.

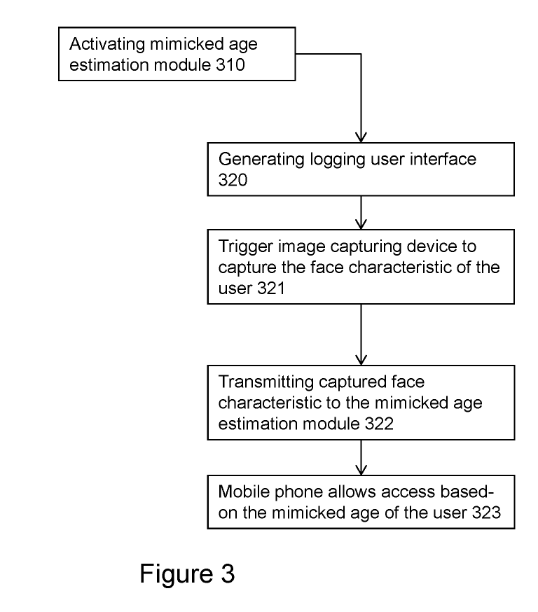

As shown in FIG. 3, it illustrates a flow chart of applying the mimicked (face recognition) age estimation module of the present invention. In the first step 310, it performs a step of activating the mimicked age estimation module 40 in the user terminal device (mobile phone) 10. After the user activates the mimicked age estimation module 40, a logging user interface is then transmitted to the remote server 38 and displayed on the display 30 in step 320. In the step 321, the user face-characteristic is captured by the image capturing device 28. Another method is to detect the user image by the sensor. The sensor could be optical sensor such as CMOS sensor or CCD. The user face-characteristic may be stored in the memory 24 of the mobile phone 10. Then, in the step 322, the captured face-characteristic is transmitted to the mimicked age estimation module 40 to determine, judge or mimic age of the user to generate a mimicked age of the user by the captured face image. The mimicked age of the user may be displayed on the display 30. In the step 323, the mobile phone allows access based-on the mimicked age of the user. In another embodiment, in the step 323, an age identification module is used for age identification such that the mobile phone allows access. For example, a specified website is accessed based-on the mimicked age of the user. The face recognition age estimation module is used to mimic the captured face image to generate a mimicked age of user, and the mobile phone 10 allows access based-on the mimicked age of the user. In one embodiment, the specified website can be accessed if the mimicked age of the user exceeds a set (predetermined) age; the specified website is forbidden to be accessed if the mimicked age of the user does not exceed the set age. The specified website is for example sports ticket website, movie ticket website, or trade articles website, for providing internet booking (sport ticket, movie ticket, concert ticket), or online shopping (such as buying cigarette, any alcoholic drink.). In another embodiment, vending machine is applied based-on the mimicked age of the user. In yet another embodiment, as the user clicks the mimicked age of the user on the display 30, some application programs can be displayed on the display 30; the mimicked age of the user is just for fun without any age restriction or rating restriction.

The mimicked age may be transmitted to a specified website or a vending machine by a wireless transmitting module. The wireless transmitting module is a WiFi module, blue tooth module, or NFC (Near Field Communication) transmission module. After the mimicked age is confirmed, the mobile phone allows accessing into the specified website or the vending machine for buying or transaction.

In another embodiment, a personal identification module employed to replace the age estimation module 40 is coupled to the processing unit 12 to provide age of the user by the data stored in the personal identification module 50. The personal identification module 50 is issued by government, official agency, or the merchant, bank and so on. The personal identification module 50 could be electrical credit card, cash card, banking card which may provide the personal age information. Under the embodiment, the age identification module 50 is optional or maybe omitted. The above personal identification module is employed for age identification.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

I claim:

1. A mobile phone, comprising:
a control unit;
a memory coupled to said control unit;
a sensor formed in said mobile phone for capturing a user's face image;
a mimicked age estimation module coupled to said control unit to generate a mimicked age of said user by said captured face image; and
an age identification module coupled to said control unit for age identification.

2. The mobile phone of claim 1, further comprising a light source formed on said mobile phone to project light to said user's face.

3. The mobile phone of claim 1, further comprising a camera formed on said mobile phone.

4. The mobile phone of claim 1, wherein a video message is sent to a remote web system by WiFi or mobile communication protocol from said mobile phone.

5. The mobile phone of claim 1, wherein a specified website can be accessed if said mimicked age of said user exceeds a set age.

6. The mobile phone of claim 1, wherein said sensor is an image capturing device.

7. The mobile phone of claim 1, further comprising a voiceprint template.

8. The mobile phone of claim 7, further comprising a microphone.

9. The mobile phone of claim 1, wherein a website or vending machine is accessed based-on said mimicked age of said user.

10. The mobile phone of claim 1, wherein said mobile phone allows access based-on said mimicked age of said user.

11. A mobile phone, comprising:
a control unit;
a memory coupled to said control unit;
a sensor formed in said mobile phone for capturing a user's face image;
a mimicked age estimation module coupled to said control unit to generate a mimicked age of said user by said captured face image; and
a wireless transmitting module coupled to said control unit to transmit said mimicked age from said mobile phone to an external device for age identification.

12. The mobile phone of claim 11, wherein said wireless transmitting module is a WiFi module, blue tooth module, or NFC transmission module.

13. The mobile phone of claim 11, wherein a specified website can be accessed if said mimicked age of said user exceeds a set age.

14. The mobile phone of claim 11, wherein said sensor is an image capturing device.

15. The mobile phone of claim 11, wherein a website or vending machine is accessed based-on said mimicked age of said user.

16. A mobile phone, comprising:
a control unit;
a memory coupled to said control unit;
a sensor formed in said mobile phone for capturing a user's face image;
an age identification module coupled to said control unit to provide a user age information; and
a wireless transmitting module coupled to said control unit to transmit said user age information from said mobile phone to an external device for age identification.

17. The mobile phone of claim 16, wherein said wireless transmitting module is a WiFi module, blue tooth module, or NFC transmission module.

18. The mobile phone of claim 16, wherein a website can be accessed if said user age exceeds a set age.

19. The mobile phone of claim 16, wherein said sensor is an image capturing device.

20. The mobile phone of claim 16, wherein a website or vending machine is accessed based-on said user age information.
